(19) United States
(12) Patent Application Publication
(10) Pub. No.: US 2026/0049795 A1
(43) Pub. Date: Feb. 19, 2026

(54) SYSTEM AND METHOD FOR KINETIC INTERCEPTION OF AN AIRCRAFT

(71) Applicant: Fortem Technologies, Inc., Pleasant Grove, UT (US)

(72) Inventors: Matthew ARGYLE, Lindon, UT (US); Devin LEBARON, Saratoga Springs, UT (US); James BRIDGE, Provo, UT (US); Jacob OLSON, Orem, UT (US); Spencer PROWS, Pleasant Grove, UT (US); Jeremy SOMMER, Lake Park, MN (US); Magnus WALLMARK, Austin, TX (US); Adam ROBERTSON, Provo, UT (US)

(21) Appl. No.: 18/808,333

(22) Filed: Aug. 19, 2024

(51) Int. Cl. F41H 11/02; B64U 20/80; B64U 101/16; F41G 7/22

(52) U.S. Cl. CPC F41H 11/02; B64U 20/80; F41G 7/2246; F41G 7/2286; B64U 2101/16; B64U 2201/10

(57) ABSTRACT

A system and method are provided to defend against intruding aircraft using an intercept aircraft to detonate a radar/kinetic projectile package in proximity to the unwanted aircraft. The projectile device shoots projectiles through the intruding aircraft to disable it. The intercept aircraft includes a radar, a projectile device, and processors operating on radar data to detect the intruding aircraft and predict its path. The intercept aircraft is flown to an intercept point on the predicted path, where the intercept aircraft waits for the intruding aircraft and then detonates an explosive launching the projectiles through the intruding aircraft thereby disabling it and also achieving the self-destruction of the radar/kinetic projectile package and one or more parts (e.g., secret or proprietary parts) of the radar and/or the intercept aircraft.

### RELATED APPLICATION

The present disclosure relates to application Ser. No. XX/YYY,ZZZ (Docket No. 092146-775466), filed on the same day as the present application, and U.S. patent application Ser. No. 17/316,433, filed May 10, 2021, now U.S. Pat. No. 11,498,679, issued Nov. 15, 2022, which are incorporated herein in their entirety by reference.

### TECHNICAL FIELD

The present disclosure relates to a new structure of kinetic projectiles that are shot from a projectile module configured on a drone. The kinetic projectiles interact with a target drone to disable the target drone.

### BACKGROUND

Although drone technology has been around for half a century, recent advances in drone technology have increased the security risks associated with drones intruding in restricted airspaces. Consequently, there is increasing demand for defense systems to counteract these security risks.

Advancements in drone technology have reduced the price and size of drones, eventually making them more readily available to individual consumers. With an increase in consumer drones, problems began to surface regarding privacy, trespassing, and security issues.

In view of the ability of many drones to fly at high altitudes, drone defense systems must also be able to fly at high altitudes to remove an unwanted drone from a designated property. Also, many drones can carry a payload, which raises security issues concerning hostile applications such as carrying and deploying an explosive or harmful chemical agent. Not being able to remove or eliminate potentially threatening drones can be a major problem for governments, event planners, or any landowner. Defense drones that can shoot/project a net have been proposed to capture or disable unwanted drones, such as quadcopters of limited size and speed.

However, there is not a one-size-fits-all solution for drone defense because there is a wide spectrum of drones, many of which are too big or too fast to be captured using a net-based solution. For example, drones can span a wide spectrum of costs and capabilities. At one end of the spectrum, a sophisticated, expensive drone such as a WING LONG or SKY SAKER drone by NOINCO can cost millions of US dollars, can weigh about 2,400 pounds, can have a range of about 2000 miles, and can attain speeds of about 170 mph. These larger drones can be defended against using traditional air defense systems, such as the PARTIOT surface-to-air missile system.

At the other end of the spectrum, small individual consumer drones can cost in the neighborhood of thousands of US, dollars, and these consumer drones can have capabilities of carrying payloads weighing several pounds. Because these consumer drones are comparatively slow and small, net-based air defense systems (such as those discussed above) can be effective in defending against these consumer drones.

In between these two ends of the spectrum are medium-cost drones such as the Iranian-built HESA SHAHED drones, which weigh about 400 pounds, can carry warheads weighing about one hundred pounds, can travel at speeds of about 110 mph, and have a range of up to 1500 miles. Providing defenses against these medium-cost drones can present challenges because net-based solutions might not be very effective against larger and/or faster drones. Traditional air-defense systems might be cost ineffective against medium-cost drones.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a diagram of an example of a system for defending against a target aircraft, in accordance with some example implementations.

FIG. 1B illustrates a diagram of the system determining an intercept point along a path of the target aircraft, in accordance with some example implementations.

FIG. 1C illustrates a diagram of the system intercepting the target aircraft, in accordance with some example implementations.

FIG. 2A illustrates a diagram of an example of an intercept aircraft, in accordance with some example implementations.

FIG. 2B illustrates a diagram of an example of a radar/kinetic projectile package that mounts on the intercept aircraft, in accordance with some example implementations.

FIG. 2C illustrates a diagram of an example of a radar/kinetic projectile package, in accordance with some example implementations.

FIG. 2D illustrates diagram of an example of a radar/kinetic projectile package, in accordance with some example implementations.

FIG. 3A illustrates a flow diagram of a method for defending against the target aircraft, in accordance with some example implementations.

FIG. 3B illustrates another flow diagram illustrating a method of providing a kinetic intercept of a target aircraft, in accordance with some example implementations.

FIG. 4 illustrates a block diagram of an example of a computing device, in accordance with some example implementations.

### DESCRIPTION OF EXAMPLE IMPLEMENTATIONS

### Brief Introduction

Disclosed are a system and method associated with a flying machine (e.g., a drone or a quadcopter) that provides air defense against unwanted aircraft in a given air space by performing a kinetic interception of the unwanted aircraft. In some aspects, it may not be desirable in case a defensive drone is captured to enable a bad actor to identify the technology on the defensive drone. Thus, in some cases, the kinetic interception may include an explosive configured on a defensive drone (or other aircraft) that not only explodes to take down the unwanted aircraft but that also purposefully destroys at least one system or component (such as a radar or an antenna structure) of the defensive drone.

Various example/implementations of the disclosure are discussed in detail below. While specific implementations are discussed, it should be understood that this is done for illustration purposes only. A person skilled in the relevant art will recognize that other components and configurations may be used without parting from the spirit and scope of the disclosure.

In some aspects, the techniques described herein relate to a method of kinetically intercepting of an aircraft, the method including: detecting, by an intercept aircraft, a target aircraft; predicting a path of the target aircraft to determine a predicted path; controlling the intercept aircraft to fly to an intercept point along the predicted path; and initiating a kinetic interception of the target aircraft that includes a self-destruction of one or more parts of a radar/kinetic projectile package that performs the kinetic interception of the target aircraft.

In some aspects, the techniques described herein relate to a system including: a fuselage of an intercept aircraft; a radar/kinetic projectile package fixed to the fuselage of the intercept aircraft; one or more processors; and a memory storing instructions that, when executed by the one or more processors, configure the system to: detect a target aircraft; predict a path of the target aircraft to determine a predicted path; control the intercept aircraft to fly to an intercept point along the predicted path; and initiate a kinetic interception of the target aircraft that includes a self-destruction of one or more parts of the radar/kinetic projectile package that performs the kinetic interception of the target aircraft.

In some aspects, the techniques described herein relate to a radar/kinetic projectile package, including: an attachment member configured to attach the radar/kinetic projectile package to a fuselage of intercept aircraft; an explosive; and projectiles arranged next to the explosive, wherein the projectiles are arranged such that a detonation of the explosive launches the projectiles within a predefined solid angle in a direction with respect to the fuselage of the intercept aircraft.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### EXAMPLE IMPLEMENTATIONS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for air defense systems for disabling intrusive aircraft via kinetic interception. For example, an unwanted aircraft may enter restricted airspace or may present a security risk. Although other solutions (e.g., conventional air defense systems or net-based air defense systems) could disable unwanted aircraft to mitigate security risks, these other solutions might not be the best solution for certain aircraft. For example, conventional air defense systems might be overkill, costing significantly more than the unwanted aircraft, and therefore they would be too expensive. Additionally, net-based air defense systems might be ineffective for disabling unwanted aircraft, resulting in an unreasonably high percentage of unwanted aircraft breaching the air defense.

According to certain non-limiting examples, the solution described herein is kinetic-interception air defense that predicts the path of an unwanted aircraft, flies an intercept aircraft to an intercept point along the predicted path, where the intercept aircraft waits for the unwanted aircraft, and detonates a radar/kinetic projectile package 120 upon the unwanted aircraft's arrival at the intercept point. Similar to a landmine or a naval mine, the intercept aircraft can deter and mitigate unwanted intruders by detonating an explosive with the intruder is nearby. Further, ball bearings, pellets, fragments (which can be metal or ceramic, plastic or other material) or other components can be packed near to explosive to provide shrapnel that is directed within a predefined solid angle to shred or hit critical parts of the unwanted aircraft thereby disabling the unwanted aircraft by rendering one or more critical parts unsuitable for flight. For example, the shrapnel can hit electronics components, controllers, processors, sensors, motors, wings, steering components, or any other parts that are required separately or in combination to provide flight capabilities.

According to certain non-limiting examples, the intercept aircraft flies to and then hovers below the intercept point to wait for the target aircraft. A kinetic interception in which the intercept aircraft detonates an explosion below the target aircraft has the benefit that aircraft are generally not designed to resist stress on the wings due to an upward force on the fuselage. That is, in flight, the upward lift forces on the wings are transferred to the fuselage. Consequently, the connection between the wings and the fuselage is reinforced to withstand more upward force on the wings than on the fuselage, but the connection is not reinforced for a much greater upward force on the fuselage than on the wings. Thus, an explosion below the aircraft, as opposed to above, can be more effective at damaging the connection between the wings and the fuselage, thereby disabling the target aircraft.

Further, the intercept aircraft may also include a self-destructing component such that upon the implementation of the kinetic interception, a radar or other component is purposefully destroyed so that the technology associated with that component on the intercept aircraft cannot be reverse-engineered by a bad actor.

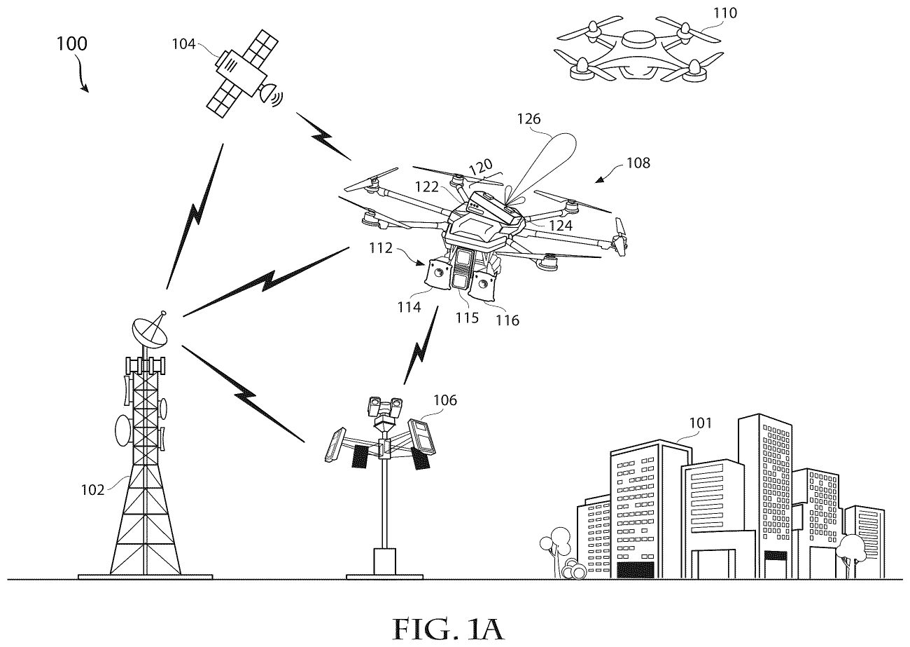

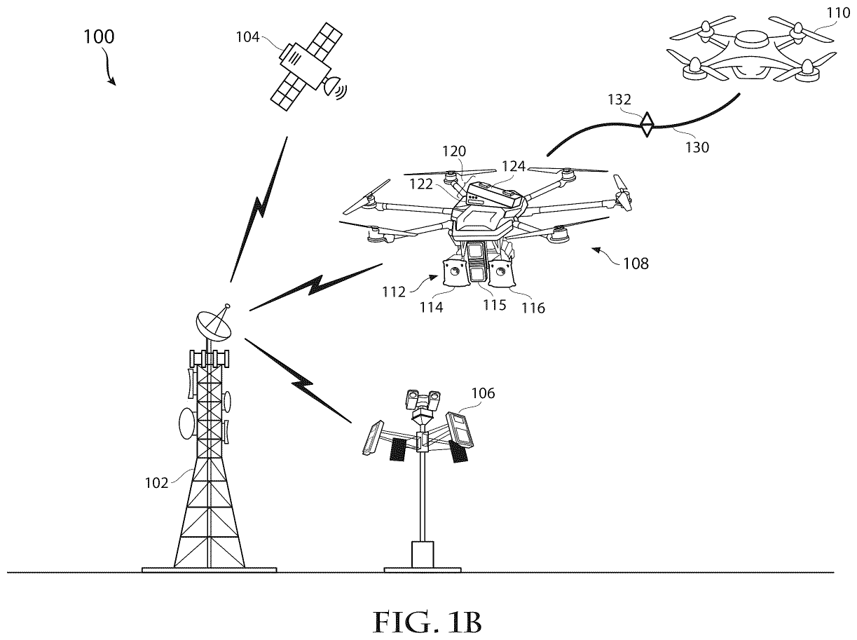

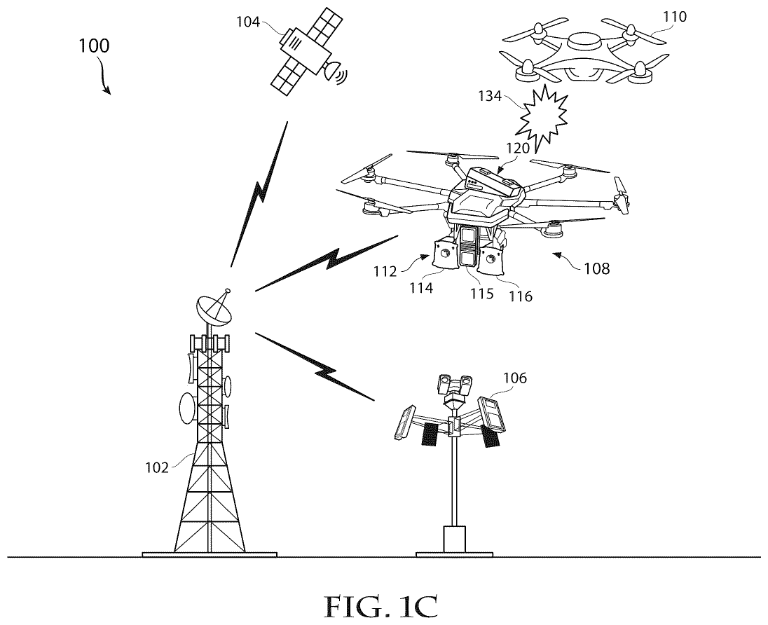

FIG. 1A illustrates an aircraft environment 100 for detecting and mitigating a target aircraft 110 (e.g., a drone that is trespassing into restricted airspace). The aircraft environment 100 can include one or more communication towers 102, one or more satellites 104, one or more ground-based radar and camera system 106, an intercept aircraft 108 and a target aircraft 110. The aircraft environment 100 can include buildings such as would exist in a city 101. The one or more ground-based radar and camera system 106 can include a radar and/or a camera system that can provide one or more of radar data and visual data for validation of the target aircraft 110 and optical classification. The one or more satellites 104, the one or more ground-based radar and camera system 106, and the intercept aircraft 108 can be configured with radar systems that perform various functions for detection, ranging, and tracking the location of the target aircraft 110. Furthermore, the one or more communication towers 102, the one or more satellites 104, the one or more ground-based radar and camera system 106 and the intercept aircraft 108 can include communication components that enable each respective device to communicate with other devices in the aircraft environment 100. In this manner, the intercept aircraft 108 can obtain information about the position, classification, and/or movement of the target aircraft 110 from one or more sources of data and move into the proper position for implementing a kinetic intercept as disclosed herein.

In some aspects, a radar and projectile system 112 of the intercept aircraft 108 can have a first projectile package 114, a set of antenna arrays 115 and a second projectile package 116. As shown, the radar system is configured on a side of the intercept aircraft 108. The radar and projectile system 112 is optional on the intercept aircraft 108 in that there is also another radar system disclosed which is the focus of this application. The different radar systems disclosed herein may be the same or different. For example, the set of radar antenna arrays 115 may represent an older technology that competitors or bad actors may already be aware of. A new more proprietary technology may be deployed in the radar system disclosed below which would be destroyed as part of kinetic intercept operation.

A radar/kinetic projectile package 120 can be configured on the intercept aircraft 108. The radar/kinetic projectile package 120 can include a kinetic projectile component 122, an explosive 121, projectiles 123 and a radar antenna 124 configured together, adjacent to each other or in some other manner configured to enable projectiles in the kinetic projectile package 120 to interact with the radar antenna 124 upon deployment. The radar/kinetic projectile package 120 can include an attachment member (not shown) configured to attach the radar/kinetic projectile package 120 to a fuselage of intercept aircraft 108. The attaching member may be screws, an adhesive, or any other type of attachment member. Note as well that the radar/kinetic projectile package 120 may be removable or replaceable with a different radar/kinetic projectile package 120 depending on the task at hand. Thus, the attachment member can enable the radar/kinetic projectile package 120 to be removed and replaced from the intercept aircraft 108.

A directional antenna gain 126 is shown for the radar antenna 124 that directs a significant portion of the radiated electromagnetic energy in a relatively small solid angle (e.g., but not limited to, a solid angle less than 1 steradian, a solid angle less than 0.5 steradians, a solid angle less than 0.25 steradians, or a solid angle less than 0.1 steradians).

As noted above, an aspect of this disclosure relates to deploying a kinetic intercept to take down the target aircraft 110. In some aspects, the kinetic intercept can include the purposeful destruction of a component or system on the intercept aircraft 108. For example, the radar antenna 124 or components of the radar/kinetic projectile package 120 may be desirable to destroy as part of the kinetic intercept. The purpose of destroying part of the radar/kinetic projectile package 120 may be to protect the knowledge of the structure of the radar antenna 124 from falling into the wrong hands.

The radar antenna 124 in the radar/kinetic projectile package 120 can be arranged such that the main lobe of the radar signal or the directional antenna gain 126 is pointed along a direction of travel when the intercept aircraft 108 is operating near its maximum velocity. For example, to reach its maximum horizontal velocity, the intercept aircraft 108 can be oriented at a pitch angle of 65°. In this case, the radar of the intercept aircraft 108 would be oriented substantially close to 65° from a horizontal axis of the intercept aircraft 108 (e.g., but not limited, 65°±20°). This accounts for the intercept aircraft 108 being oriented near the pitch angle of approximately 65° when the intercept aircraft 108 is seeking for a target aircraft 110 along the horizon. Such an arrangement enables the intercept aircraft 108 to travel at near optimal speeds while also being able to detect and track a target aircraft 110 at long distances.

According to certain non-limiting examples, the system of the radar/kinetic projectile package 120 together with the intercept aircraft 108 can be arranged and oriented such that the radar antenna 124 and the kinetic projectile component 122 (e.g., which can be a combination of an explosive together with the kinetic projectiles such as projectiles 123) respectively have fixed orientations relative to the body of the intercept aircraft 108. The fixed orientation is selected such that the projectiles are launched in a direction such that the radar/kinetic projectile package 120 is orientated to launch the projectiles in a direction is substantially aligned with the directional antenna gain 126. For example, the radar antenna 124 can be orientated to have an antenna gain that is substantially maximum in a given direction, and the given direction is substantially along the travel direction of the intercept aircraft 108 when it is traveling at a maximum speed.

As used herein, the directional antenna gain 126 that is substantially maximum means that the antenna gain is within 20% of the maximum antenna gain (e.g., the antenna gain is 80% or greater of the maximum antenna gain). As used herein, a direction that is substantially along a travel direction means the direction deviates by less 20° from the travel direction.

According to certain non-limiting examples, the radar antenna 124 in the radar/kinetic projectile package 120 can be a phased array antenna that provides a degree of beam steering, but the greatest antenna gain can be obtained for steering angles near normal incidence to the antenna array.

According to certain non-limiting examples, one or more of the radar and projectile system 112 and radar antenna 124 on the intercept aircraft 108 can obtain angle, range, and velocity measurements for the target aircraft 110, which can then be used to predict the path/trajectory to be traversed by the target aircraft 110. Using the predicted path, the intercept aircraft 108 can select an intercept point along the path, fly to and then hover at a point just below the intercept point, where the intercept aircraft 108 waits to detonate a kinetic projectile in the kinetic projectile component 122 to disable the target aircraft 110 as well as destroy or disable the radar antenna 124.

FIG. 1A also shows a first projectile package 114 and a second projectile package 116 which can each contain a respective projectile such as a net or other projective for capturing the target aircraft 110. A control system (not shown) would be used to deploy projectiles from the first projectile package 114 or the second projectile package 116.

FIG. 1B illustrates the intercept aircraft 108 flying along a predicted path 130 of the target aircraft 110 to an intercept point 132. The intercept aircraft 108 then hovers while waiting for the predicted instance (i.e., when the intercept aircraft 108 is a certain distance from the target aircraft 110) to detonate the kinetic projectile component 122 to deploy the projectiles 123 towards the target aircraft 110.

FIG. 1C illustrates the intercept aircraft 108 performing the kinetic interception 134 of the target aircraft 110, e.g., by detonating the explosive or the kinetic projectile component 122, which is arranged as a directed charge to launch the projectiles 123 toward intercept point 132 and for a kinetic interception 134 with the target aircraft 110.

According to certain non-limiting examples, the kinetic interception 134 can disable both the intercept aircraft 108 and the target aircraft 110. Whereas some smaller or slower aircraft such as quadcopters can be captured and disabled using nets, nets (which might be deployed from the first projectile package 114 or the second projectile package 116) might not work to disable larger and/or faster aircraft such as target aircraft 110. The kinetic interception 134 can, however, disable larger and/or faster aircraft than net-based interception techniques. The explosive charge used for kinetic interception 134 can result in the intercept aircraft 108 being a single-use device for performing the kinetic interception 134. For example, an explosion originating from the intercept aircraft 108 that is large enough to disable the target aircraft 110 is also likely to cause significant damage to the intercept aircraft 108 itself.

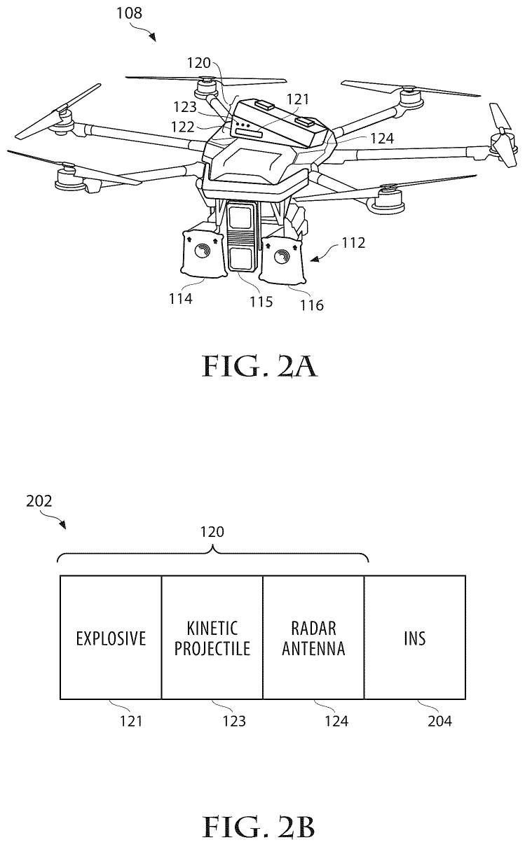

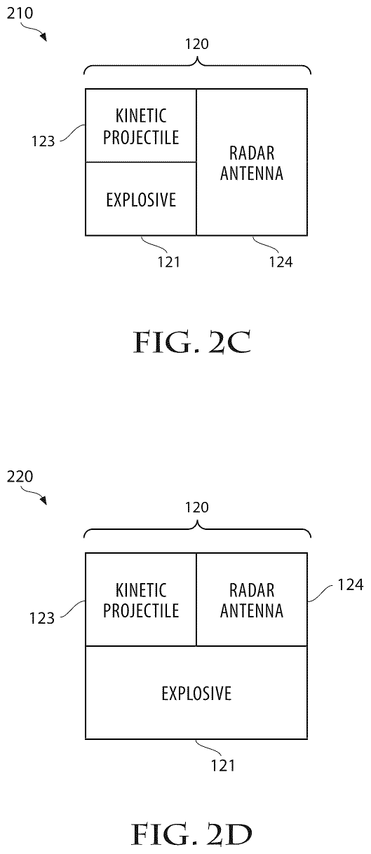

FIG. 2A shows the intercept aircraft 108 (e.g., a quadcopter) that can include a radar/kinetic projectile package 120 with the kinetic projectile component 122 and the projectiles 123.

FIG. 2B shows a radar and navigation system architecture 202 which can be configured on a flying device such as intercept aircraft 108 and including an internal navigation system (INS) 204, the radar/kinetic projectile package 120 which can include an explosive or kinetic projectile component 122, a kinetic projectile such as projectiles 123, and a radar antenna 124. The explosive or kinetic projectile component 122 is arranged to provide a directed charge through the projectiles 123, which can be metal or ceramic pellets/fragments that are accelerated through the radar antenna 124 to generate additional high-velocity fragments. Other materials are considered as well such as plastics for the pellets or fragments.

The radar antenna 124 can have dual uses: (1) as part of a radar and (2) as shrapnel generated during the kinetic interception 134. First, the radar antenna 124 is used for secking the target aircraft 110 and used for proximity fusing to determine when the target aircraft 110 is sufficiently close to detonate the explosive or the kinetic projectile component 122. Second, the explosion or the kinetic projectile component 122 accelerates fragments of the radar antenna 124 to hit and cause damage to the target aircraft 110.

Additionally, the destruction of the intercept aircraft 108 can be beneficial especially when the intercept aircraft 108 operates in a region where an adversary might recover remnants/debris from the intercept aircraft 108 and then use the debris to reverse engineer the technology used in the intercept aircraft 108. Thus, destroying the radar antenna 124 and other proprietary or confidential technologies in the intercept aircraft 108 can prevent others from obtaining pieces of the intercept aircraft 108 and based on these pieces copying part of all of the technology.

Moreover, the intercept aircraft 108 can include additional self-destruct devices that are initiated concurrently or immediately after detonating the explosive or the kinetic projectile component 122.

FIG. 2C illustrates a diagram of an example of a radar/kinetic projectile package 210, in accordance with some example implementations. The radar/kinetic projectile package 210 can include the radar/kinetic projectile package 120 which can include an explosive or kinetic projectile component 122, a kinetic projectile such as projectiles 123, and a radar antenna 124. FIG. 2C illustrates an example implementation where the relative position of these various components differs from the relative positions shown in FIG. 2B. Rather than being side-by-side in a series as shown in FIG. 2B, the radar antenna 124 is essentially adjacent to both the kinetic projectile component 122 and the projectiles 123.

FIG. 2D illustrates diagram of an example of a radar/kinetic projectile package 220, in accordance with some example implementations. The radar/kinetic projectile package 220 can include the radar/kinetic projectile package 120 which can include an explosive or kinetic projectile component 122, a kinetic projectile such as projectiles 123, and a radar antenna 124. FIG. 2D illustrates an example implementation where the relative position of these various components differs from the relative positions shown in FIG. 2B and FIG. 2C. Rather than being side-by-side in a series as shown in FIG. 2B or where the radar antenna 124 is adjacent to both the kinetic projectile component 122 and the projectiles 123 as in FIG. 2C, FIG. 2D shows the radar/kinetic projectile package 220 below and adjacent to both the projectiles 123 and the radar antenna 124.

According to certain non-limiting examples, the projectile device (which can be either the entire radar/kinetic projectile package 120 or the combination formed by the explosive or the kinetic projectile component 122 together with the projectiles 123) can be detachable from the intercept aircraft 108. Further, the projectile device can include a communication port for communicating between the projectile device and at least one processor of the one or more processors such as processor 404 and/or the INS 204.

The radar/kinetic projectile package 120 can refer also to any of the projectile packages disclosed herein with the various configurations.

According to certain non-limiting examples, the projectile device (e.g., the radar/kinetic projectile package 120, the first projectile package 114 or the second projectile package 116) snaps onto the intercept aircraft 108, and, after snapping onto the intercept aircraft 108, the projectile device is secured at two or more points via fasteners (e.g., bolts) extending through the projectile device and threading into a fuselage/body of the intercept aircraft 108.

According to certain non-limiting examples, the communication port is a wired port that electrically connects the projectile device to the intercept aircraft 108 when the projectile device is fixed to the intercept aircraft 108. For example, the communication port can be a parallel port, a serial port, a DIN port, an RS-232C, an RS-422A, an RS-485, DE-9 port, a DB-25 port, a USB port, an ethernet port, a ruggedized port, or a firewire port. Additionally, the communication port can provide electrical power from the intercept aircraft 108 to the projectile device.

According to certain non-limiting examples, the intercept aircraft 108 has an electrical power supply, and the projectile device snaps has another electrical power supply that is separate from the electrical power supply of the intercept aircraft 108.

According to certain non-limiting examples, the communication port is a wireless port. For example, the communication port can be a BLUETOOTH communication port, a BLUETOOTH LE communication port, a NEAR FIELD communication port, a ZIGBEE communication port, a Z-WAVE communication port, a 6LoWPAN communication port, a WIFI communication port, a 3G communication port, a 4G communication port, communication port, a 5G communication port, an LTE communication port, a secure communication port, or an encrypted communication port.

According to certain non-limiting examples, the radar on the intercept aircraft 108 can be a frequency-modulated continuous wave (FMCW) radar that uses the same radar mode both for seeking and for proximity fusing. Beneficially, the radar does not need to switch modes when functioning as a seeker and as a proximity fuse. For example, without changing modes, the radar can be used as a seeker when the target aircraft 110 is far away and then be used as a proximity fuse when the target aircraft 110 is close. According to certain non-limiting examples, the radar can perform both seeking and proximity fuse functions at the same time.

According to certain non-limiting examples, the radar can obtain range information, angle information (e.g., both elevation and azimuth), and velocity information for the target aircraft 110. Obtaining all three types of information is beneficial for determining where the target aircraft 110 is currently located and predicting its future/prospective path. Further, tracking this information over time can improve predictions of the prospective path of the target aircraft 110. The predictions of the prospective path of the target aircraft 110 can also be based on position, angle, and/or velocity measurements from other radars in the aircraft environment 100 (e.g., radars in one or more ground-based radar and camera system 106 and one or more satellites 104).

According to certain non-limiting examples, the predicted path 130 can be updated as additional radar data is acquired and analyzed by components of the aircraft environment 100. Additionally, as the predicted path 130 is updated, the intercept point 132 can also be updated, and the position of the intercept aircraft 108 can be modified in accordance with the updates to the predicted path 130.

The effectiveness of the kinetic interception 134 will depend on the relative positions of the intercept aircraft 108 to the target aircraft 110 in three-dimensional (3D) space as well as the timing of the detonation of the explosive or the kinetic projectile component 122. If the timing is too soon, the projectiles 123 are harmlessly launched before the target aircraft 110 is within range or while the target aircraft 110 has not reached the blast pattern of the projectiles 123. Further, when the timing is too late, the projectiles 123 are launched after the target aircraft 110 has already exited the blast pattern of the projectiles 123. Either way, the target aircraft 110 might not sustain sufficient damage to disable the target aircraft 110 when the timing of the detonation of the explosive or the kinetic projectile component 122 is either too earlier or too late. Additionally, even when the timing is correct, the target aircraft 110 might not sustain sufficient damage, if predicted path 130 was inaccurate resulting in the intercept aircraft 108 being positioned too far from the actual location of the target aircraft 110 upon detonation of the explosive or the kinetic projectile component 122. Thus, the effectiveness of the kinetic interception 134 depends on both the accuracy of the timing of the kinetic interception 134 and the accuracy of the predicted path 130.

According to certain non-limiting examples, the blast pattern of the kinetic interception 134 can be directional. For example, the explosive or the kinetic projectile component 122 can be a directed charge that directs the projectiles 123 (e.g., a large number of metal balls, such as shotgun pellets or ball bearings, or metal or ceramic fragments) in a statistical spray pattern spanning a predefined solid angle. When the target aircraft 110 a with in a certain distance from the radar/kinetic projectile package 120 and within a certain solid angle, a target aircraft of a predefined type will be disabled with a given likelihood.

According to certain non-limiting examples, the radar/kinetic projectile package 120 has a fixed orientation with respect to a body of the intercept aircraft 108, and therefore, the body of the intercept aircraft 108 can orientated to direct the solid angle of the spray pattern to substantially overlap with the predicted path of the target aircraft 110. For example, a substantial overlap between the spray pattern of the projectiles 123 and the predicted path of the target aircraft 110 can be obtained: (i) when the center of the spray pattern is within 5° of the predicted path; (ii) when the center of the spray pattern is within 10° of the predicted path; (iii) when the center of the spray pattern is within 15° of the predicted path; (iv) when the center of the spray pattern is within 15° of the predicted path; or (v) when the center of the spray pattern is within 45° of the predicted path.

The number of projectiles in the projectiles 123 can be approximately fifty, one hundred, two hundred, one thousand, two thousand or five thousand. Any number may be used. The size and number of the projectiles 123 can depend on the type of target aircraft 110 that is anticipated to be invading a given airspace. For example, smaller kinetic projectiles with a greater number of kinetic projectiles might be preferred as the projectiles 123 to increase the likelihood of disabling unarmored aircraft, whereas fewer large kinetic projectiles might be preferred to increase the likelihood of disabling armored aircraft because larger projectiles can be more effective at penetrating the thicker skin of an armored aircraft.

According to certain non-limiting examples, the explosive or the kinetic projectile component 122 can be a liquid that is poured into a cavity (i.e., the inner volume of a container) that is determined to provide a desired dispersal pattern for the kinetic projectiles when the explosive or the kinetic projectile component 122 is detonated. Advantageously, a liquid explosive can be a mixture of two or more binaries that are non-volatile or less volatile when they are stored separately, but, when mixed together, the mixture becomes volatile.

According to certain non-limiting examples, the explosive or the kinetic projectile component 122 and the projectiles 123 can be arranged to provide a predefined dispersal pattern that is substantially uniform over the predefined solid angle.

As used herein, a pattern that is substantially uniform over the predefined solid angle means that the pattern, over the predefined solid angle, a statistical average of the density of projectiles (e.g., ball bearing, pellets, fragments) varies by less than 30%.

Handling explosives in the kinetic projectile component 122 can be dangerous, and the protective measures adopted to account for this danger can be expensive. Thus, much of the expense and danger of the explosive can be mitigated by storing the non-volatile components and then, in response to a perceived threat, mixing the non-volatile components to obtain the explosive shortly before the explosive is to be used. This approach minimizes the amount of time when the explosive presents a risk, and by minimizing this time, the additional precautionary measures and expense of handling explosives can also be minimized. Further, using a liquid explosive has the benefit that the explosive can easily be formed into any shape by using a container with an internal volume in the desired shape. The shape of the explosion pattern is somewhat influenced by the shape of the explosive upon detonation. Thus, the explosive and the resultant shape of the explosion can be tailored to achieve a desired blast pattern.

Further, in another aspect, the inner volume of a container that houses the explosive mixture can be shaped to maintain a center of gravity for the combination of the intercept aircraft 108 together with the radar/projectile package 120 substantially along a vertical axis of the intercept aircraft 108.

As used herein, substantially along a vertical axis of the intercept aircraft 108 means that, with respect to the vertical axis at a center of the machine and a most distal point on the machine from the vertical axis, a point is substantially along a vertical axis when it within 10% of the distance from the vertical axis to the most distal point.

Returning to FIG. 2A, the intercept aircraft 108 can include a flying device, such as a drone. The particular configuration of the drone can vary. While the term drone may be used herein, any flying device that has the components disclosed herein, and performs the functions described herein can apply. The intercept aircraft 108 can include circuitry (e.g., one or more processors) to control its operation. The circuitry can include an inertial navigation system (INS) 204 (shown ion FIG. 2B) and one or more processors 404. Further, the intercept aircraft 108 can include a radar that can identify a target aircraft 110 with which the intercept aircraft 108 desires to engage. The one or more processors 404 can provide movement instructions, and receive feedback from various components on the intercept aircraft 108.

The intercept aircraft 108 also includes a projectile module (e.g., radar/kinetic projectile package 120) that is attached to the intercept aircraft 108 via an attachment member/mechanism. The projectile module can be snapped into the attachment member/mechanism in a single connecting motion or slid into place using a combination of complementary components and an electronic connector as well.

In one aspect, the radar/kinetic projectile package 120 can include some or all of the computing capability necessary for running an algorithm to determine when to fire the kinetic projectile. In one aspect, some computing can occur on the radar/kinetic projectile package 120 and some computing can occur on the intercept aircraft 108. Wireless communication can occur between the intercept aircraft 108 and the radar/kinetic projectile package 120 to communicate firing instructions according to any wireless protocol such as Near Field Communication or Bluetooth.

The intercept aircraft 108 can also encompass the following features. The one or more processors 404 can be part of a computing device or a control system. The intercept aircraft 108 can include radar/kinetic projectile package 120 and a computer-readable storage medium storing instructions, which when executed by the processor, cause the processor to perform operations. The intercept aircraft 108 can include electrical communications between the controller and the radar/kinetic projectile package 120. These can be wired or wireless communications. For example, any wireless protocol such as Bluetooth can be utilized to communicate a triggering command from one or more processors 404 on the intercept aircraft 108.

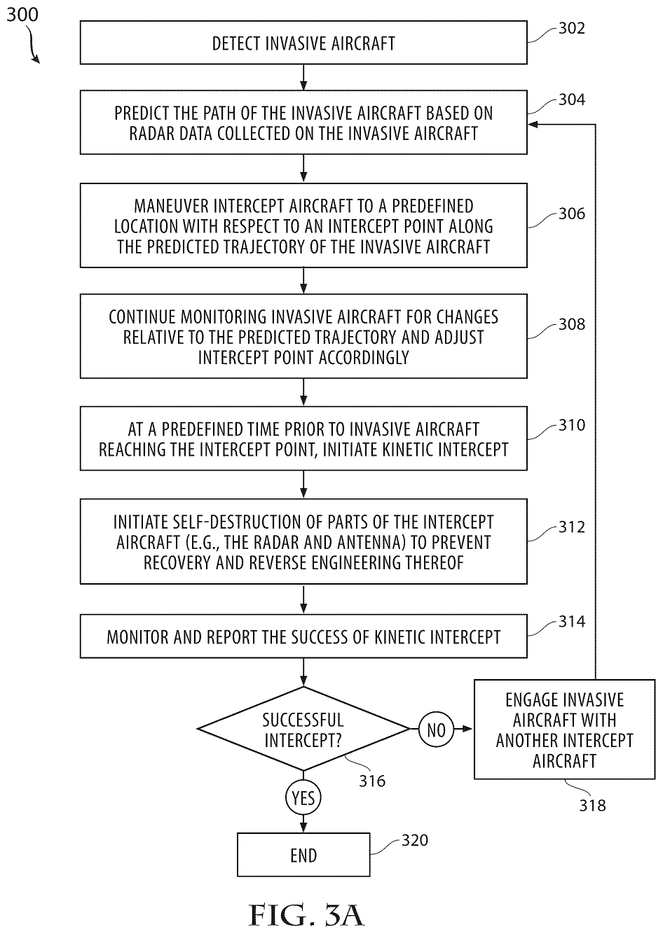

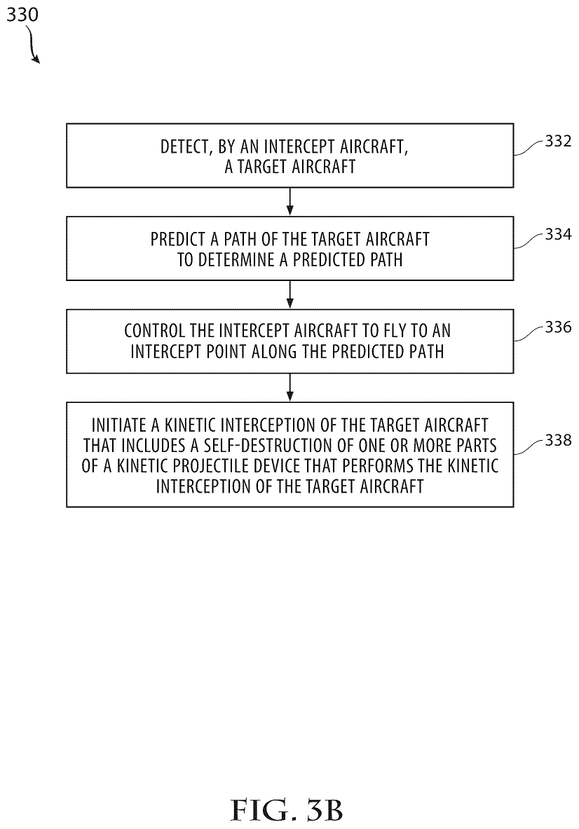

FIG. 3A illustrates an example method 300 for intercepting another aircraft (e.g., an invasive aircraft or target aircraft 110). Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 includes, via an intercept aircraft 108 or any subcomponent thereof, one or more ground-based radar and camera system 106, one or more communication towers 102, one or more satellites 104, or a combination thereof or of any subcomponents therefore, detecting invasive aircraft (or target aircraft 110) at step 302. The target aircraft 110 can be detected by one or more radars in the aircraft environment 100, including, e.g., the one or more satellites 104, the one or more ground-based radar and camera system 106, or the radar on the intercept aircraft 108. For example, the radar on the intercept aircraft 108 can function as a seeker to detect and monitor the position of the target aircraft 110.

According to certain non-limiting examples, the intercept aircraft 108 includes a radar that detects the target aircraft 110 by transmitting a radio signal and then detecting the scattered radio signal from the target aircraft 110. The radar can use an FMCW radar mode and a phased array antenna. Further, based on the measurements of the scattered radio signal, the radar can determine the relative distance (range), angle (e.g., azimuthal angle and elevation angle), and speed of the target aircraft 110 relative to the intercept aircraft 108. That is, based on the measured scattered radio signal, the intercept aircraft 108 can determine the position (e.g., distance and angle) and the velocity of the target aircraft 110. Further, by monitoring the position and velocity of the target aircraft 110 over time, the intercept aircraft 108 can predict where the target aircraft 110 is going in the future (i.e., the prospective path of the target aircraft 110).

According to some examples, in step 304, the prospective/future path of the target aircraft 110 (i.e., the predicted path 130) is predicted using the collected radar data. The predicted path 130 can be based on measurements of the position, velocity, angle, acceleration, and change in the direction of the target aircraft 110 at a series of times. As discussed below with respect to step 308, the radar measurements can be ongoing, and the predicted path 130 can be updated based on the ongoing radar measurements. These radar measurements can include measurements by the radar on the intercept aircraft 108 as well as measurements by other radars in the aircraft environment 100, including, e.g., the one or more satellites 104 and the one or more ground-based radar and camera system 106.

According to some examples, in step 306, an intercept point is selected along the predicted path 130, and the intercept aircraft 108 is directed to fly to a predefined location with respect to the intercept point 132 along the predicted path 130 of the target aircraft 110.

According to certain non-limiting examples, the intercept aircraft 108 includes a kinetic interception device that shoots projectiles in an upward direction. The intercept aircraft 108 hovers in place waiting for the target aircraft 110 to pass above the intercept aircraft 108. At a predefined time interval before the target aircraft 110 passes through intercept point 132, an explosive or kinetic projectile component 122 is detonated launching the projectiles 123 to hit the target aircraft 110 when it reaches intercept point 132. The time delays associated with the electronics, detonation process, and travel of the projectiles 123 to intercept point 132 can be precisely determined to ensure the projectiles 123 hit the target aircraft 110 thereby ensuring the effectiveness of the kinetic interception 134 for disabling the target aircraft 110.

Further, the distance between the predicted path 130 and the location at which the intercept aircraft 108 hovers and waits for the target aircraft 110 can be selected to ensure an effective distance between the intercept aircraft 108 and the target aircraft 110 for the kinetic interception 134 to disable the target aircraft 110 with a near optimal likelihood. For example, the intercept aircraft 108 can hover between 0.5 meters and 1 meter below the predicted path 130, or the intercept aircraft 108 can hover between 1 meter and 3 meters below the predicted path 130. Alternatively or additionally, the intercept aircraft 108 can hover between 2 meters and 5 meters below the predicted path 130, or the intercept aircraft 108 can hover between 4 meters and 10 meters below the predicted path 130.

According to some examples, in step 308, the position and velocity of the target aircraft 110 continue to be monitored, and the predicted path 130 is updated based on the updated position and angle from the intercept aircraft 108 to the target aircraft 110. As the predicted path 130 is updated, the intercept point 132 is also updated to reflect the changes in the predicted path 130 to generate an updated predicted path, and the location of the intercept aircraft 108 is adjusted accordingly.

According to some examples, in step 310, the kinetic interception 134 is initiated at a predefined time before the target aircraft 110 reaches the intercept point 132. For example, this predefined time can account for the propagation delays through the electronics and the time from detonation until the projectiles 123 reach intercept point 132. The radar on the intercept aircraft 108 can use the same radar mode that is used for seeking the target aircraft 110 to function as a proximity fuse (i.e., the radar beneficially does not require switching modes to perform both seeking and proximity fusing functions). A proximity fuse would essentially involve causing the explosives 121 to discharge at a certain proximity from the target aircraft 110. As a proximity fuse, the radar of the intercept aircraft 108 initiates the detonation of the explosive or kinetic projectile component 122 upon the target aircraft 110 being within a predefined distance of the radar/intercept aircraft 108. This predefined distance can be adjusted based on the velocity of the target aircraft 110, such that the projectiles 123 pass through intercept point 132 while the target aircraft 110 is at intercept point 132.

According to certain non-limiting examples, at a predefined time interval before the target aircraft 110 passes through intercept point 132, an explosive or kinetic projectile component 122 is detonated launching the projectiles 123 to hit the target aircraft 110 when it reaches intercept point 132. The time delays associated with the electronics, detonation process, and travel of the projectiles 123 to intercept point 132 can be precisely determined to ensure the effectiveness of the kinetic interception 134 for disabling the target aircraft 110.

According to some examples, the method includes a self-destruct functionality that prevents capture and reverse engineering of the intercept aircraft, and this self-destruction functionality is performed to destroy the intercept aircraft at step 312. As illustrated in the non-limiting example of FIG. 2B, the radar antenna 124 (and possibly other radar components) can be arranged to be shredded by the detonation of the explosives 121 by launching the projectiles 123 through the radar antenna 124. This destruction of the radar antenna 124 (and possibly other radar components) prevents a competitor/enemy from gathering debris from the intercept aircraft 108 to reverse engineer the radar system or other parts of the intercept aircraft 108. Generally, the explosives 121 can achieve the destruction and eradication of secret and/or proprietary components from being salvaged and copied by others. Additionally, the intercept aircraft 108 can include a self-destruct functionality that is activated when the intercept aircraft 108 is disabled in a region where retrieval is not assured, and the self-destruct functionality is used to destroy and eradicate the secret and/or proprietary components of the intercept aircraft 108.

According to some examples, in step 314, after the kinetic interception 134, a component of the aircraft environment 100 continues to monitor and report on whether the kinetic interception 134 was successful in disabling the target aircraft 110. For example, the one or more ground-based radar and camera system 106 and/or radars on the satellites 104 can determine whether the target aircraft 110 continues flying or falls to the ground.

According to some examples, at decision block 316, when the kinetic interception 134 was not successful, method 300 continues to step 318. Otherwise, method 300 ends at step 320, until another target aircraft 110 is detected.

According to some examples, at step 318, another intercept aircraft such as intercept aircraft 108 is engaged to perform the kinetic interception 134, and method 300 continues from step 318 to step 304 at which a component of the aircraft environment 100 predicts the predicted path 130 of the target aircraft 110.

Now, additional and/or alternative implementations of method 300 are discussed. The first flying machine discussed below is the intercept aircraft 108, and the second flying machine discussed below is the target aircraft 110.

According to certain non-limiting examples, intercept aircraft 108 is configured to detect, navigate to, and disable the target aircraft 110 via a kinetic interception 134 in which many (e.g., about one hundred, about two hundred, about five hundred, about one thousand, about two thousand, five thousand, or more) kinetic projectiles are launched via a propellant (e.g., an explosive) towards the target aircraft 110 to perform the kinetic interception 134 of the target aircraft 110. Further, the radar on the intercept aircraft 108 is configured to perform functions of both seeking the target aircraft 110 and operating as a proximity fuse for triggering the kinetic interception 134.

According to certain non-limiting examples, the radar uses a first radar mode when operating as a seeker while the range to the target aircraft 110 exceeds a first threshold, and the radar remains in the first radar mode when operating as a proximity fuse while the range to the target aircraft 110 is less than a second threshold. That is, the radar is in a first mode when operating as the seeker and the radar remains in the first radar mode when operating as the proximity fusc.

According to certain non-limiting examples, the first radar mode is a frequency modulated continuous wave (FMCW) radar mode, which is used when the radar functions as a seeker and as a proximity fuse.

According to certain non-limiting examples, the radar is used to determine the relative range, angle, and speed between the intercept aircraft 108 and target aircraft 110.

According to certain non-limiting examples, the radar data is used to: (i) predict a path/trajectory of the target aircraft 110; (ii) determine an intercept point along the predicted path/trajectory; and (iii) control the intercept aircraft 108 when flying to and then hover below the intercept point where the intercept aircraft 108 waits for a proximity-fusing event to trigger the kinetic interception 134.

According to certain non-limiting examples, the proximity-fusing event is signaled by determining that the location of the second fling machine is within a predefined range of the intercept aircraft 108.

According to certain non-limiting examples, upon the proximity-fusing event triggering the kinetic interception 134, the explosives 121 are detonated to project the projectiles 123 toward the intercept point 132.

According to certain non-limiting examples, the radar/kinetic projectile package 120 is rigidly fixed to a body of the intercept aircraft 108, and a solid angle of a projectile pattern of the projectiles 123 is oriented in a predefined direction with respect to the body of the intercept aircraft 108.

For example, the predefined direction is upward when the first flying machine is hovering at the predefined location below the intercept point.

According to certain non-limiting examples, the projectiles 123 are arranged to be launched through the radar antenna 124 and thereby generate additional projectiles from broken parts of the radar antenna 124, such that the additional projectiles contribute to a likelihood of disabling the second flying machine. Beneficially, breaking apart the radar antenna increases the difficulty of reverse engineering the radar based on debris that is recovered from the intercept aircraft 108.

According to certain non-limiting examples, the radar antenna is mounted on the kinetic projectile member, and the radar antenna is oriented to provide substantially maximum antenna gain in the direction of travel of the first flying machine when the body of the intercept aircraft 108 is oriented to enable the intercept aircraft 108 to travel at substantial maximum velocity along a horizontal direction (i.e., parallel to the Earth). As used herein, substantial maximum velocity means within 20% of the maximum velocity. As used herein, substantially maximum antenna gain means that the antenna gain is within 20% of the maximum antenna gain.

According to certain non-limiting examples, the first flying machine hovers and waits, at a predefined distance below the intercept point 132, for the second flying machine to arrive at the intercept. The predefined distance below the intercept point 132 can be, e.g., but is not limited to, 1 meter, 2 meters, or 5 meters.

According to certain non-limiting examples, updates of the radar data are used to determine updated values of the range, angle, and velocity of the target aircraft 110, which are then used to update the predicted path and intercept point. As the predicted path 130 and intercept point 132 are updated to generate an updated intercept point, the intercept aircraft 108 is repositioned based on the updated intercept point.

According to certain non-limiting examples, the kinetic interception 134 includes an explosion that disables both the first flying machine and the second flying machine, and the explosion is arranged to damage or eradicate secret portions of the radar to prevent reverse engineering thereof from recovered debris of the first flying machine. The explosion is arranged to cause the intercept aircraft 108 to self-destruct and destroy secret parts of the radar and electronics (e.g., by shredding the secret parts and electronics into pieces). The projectiles 123 can be metal pellets, ceramic or metal fragments or metal ball bearings.

According to certain non-limiting examples, the radar antenna is a phased array that is configured to perform beam steering for the transmit beam and is configured to perform coherent processing of the received backscatter.

According to certain non-limiting examples, the kinetic interception 134 is caused by detonating an explosive comprising a binary explosive mixture that is a mixture of a first liquid and a second liquid, which by themselves the first liquid and the second liquid are each inert, but when the first liquid and the second liquid are combined the combination is volatile such that detonation of the combination causes an explosion.

According to certain non-limiting examples, a shape of the explosive is determined by the shape of the inner cavity of a container that houses the binary explosive mixture. The container of the binary explosive mixture can be 3D printed to have any desired shape, and the inner volume of the container can be a predefined shape that when detonated results in an explosion profile that launches the projectiles in a predefined projectile pattern that spans a predefined solid angle.

According to certain non-limiting examples, the container of the binary explosive mixture is shaped to balance a center of gravity of the first flying machine substantially close to a mechanical center (e.g., the vertical axis) of the body of the first flying machine. Here, “substantially close” means that the center of gravity is within about 5% or about 10% of the center (e.g., the vertical axis) of the body of the intercept aircraft 108 and the most distal point on the body of the intercept aircraft 108.

According to certain non-limiting examples, the intercept aircraft 108 is configured to prevent the intercept aircraft 108 from accelerating at a rate that can cause a shock wave or compression of the explosive that is sufficiently large to detonate the explosive. For example, quadcopters that a configured for vertical takeoff and landing are subject to lower levels of acceleration than a rocket or ordinance launched from artillery.

According to certain non-limiting examples, the flying machine is configured to perform vertical takeoff and landing. For example, the intercept aircraft 108 can be a quadcopter.

According to certain non-limiting examples, a component of the aircraft environment 100 can include one or more ground radars that also detect relative values for the range, angle, and velocity of the target aircraft 110, and the predicted path is based on a combination of the radar data from the intercept aircraft 108 and the radar data from the other radars.

According to certain non-limiting examples, a component of the aircraft environment 100 includes one or more additional intercept aircrafts 108 that are also configured to intercept the target aircraft 110. These additional intercept aircrafts 108 can be activated when the ground radar determines that the kinetic interception 134 by the original intercept aircraft 108 has failed to disable the target aircraft 110.

FIG. 3B illustrates a method 330 of kinetically intercepting an aircraft. According to some examples, in step 332, the method 300 can include a system (i.e., an intercept aircraft 108 or any subcomponent thereof, a computing system 400, one or more ground-based radar and camera system 106, one or more communication towers 102, one or more satellites 104, or a combination thereof or of any subcomponents therefore) being configured to detect, by an intercept aircraft 108, a target aircraft.

According to some examples, the detecting of the target aircraft 110 further can include one or more of: generating, by a radar of the intercept aircraft 108, radar data by emitting electromagnetic radiation and detecting return electromagnetic radiation that is reflected from the target aircraft; processing the radar data using one or more processors to detect the target aircraft; processing the radar data using the one or more processors to predict the predicted path of the target aircraft and determine the intercept point on the predicted path; and flying the intercept aircraft 108 toward the intercept point on the predicted path.

According to some examples, in step 334, the method 300 can include a system (i.e., an intercept aircraft 108 or any subcomponent thereof, a computing system 400, one or more ground-based radar and camera system 106, one or more communication towers 102, one or more satellites 104, or a combination thereof or of any subcomponents therefore) being configured to predict a path of the target aircraft to determine a predicted path.

According to some examples, in step 336, the method 300 can include a system (i.e., an intercept aircraft 108 or any subcomponent thereof, a computing system 400, one or more ground-based radar and camera system 106, one or more communication towers 102, one or more satellites 104, or a combination thereof or of any subcomponents therefore) being configured to control the intercept aircraft 108 to fly to an intercept point along the predicted path.

According to some examples, in step 338, the method 300 can include a system (i.e., an intercept aircraft 108 or any subcomponent thereof, a computing system 400, one or more ground-based radar and camera system 106, one or more communication towers 102, one or more satellites 104, or a combination thereof or of any subcomponents therefore) being configured to initiate a kinetic interception 134 of the target aircraft that includes a self-destruction of one or more parts of a radar/kinetic projectile package 120 that performs the kinetic interception 134 of the target aircraft. The step of initiating the kinetic interception 134 of the target aircraft further can include detonating an explosive 121 of the radar/kinetic projectile package 120 that is arranged to launch the projectiles 123 of the radar/kinetic projectile package 120 along a predefined solid angle in a direction with respect to a body of the intercept aircraft 108.

According to some examples, the direction can be fixed with respect to the body of the intercept aircraft 108. The direction can be upward when the intercept aircraft 108 is hovering in place. In some aspects, the direction can be substantially horizontal when the intercept aircraft 108 is traveling at near maximum velocity. In other aspects, the direction can be substantially along a direction of maximum antenna gain for a radar of the intercept aircraft 108.

According to some examples, the self-destruction of the one or more parts of the radar/kinetic projectile package 120 includes that an antenna of a radar is oriented relative to the projectiles and the explosive such that the projectiles are launched through the antenna of the radar of the intercept aircraft 108 thereby breaking the antenna of the radar into pieces that are launched in the direction.

The projectiles 123 can include more than one hundred projectiles and wherein the more than one hundred projectiles comprise ball bearings or metal pellets or fragments which can be metal, ceramic or another material.

The method 330 can include one or more steps of: using the radar of the intercept aircraft 108 for seeking the target aircraft; using the radar of the intercept aircraft 108 for proximity fusing the radar/kinetic projectile package; and using a same radar mode for the seeking of the target aircraft and for the proximity fusing of the radar/kinetic projectile package.

In some aspects, the same radar mode that is used for the seeking and for the proximity fusing is a frequency-modulated continuous wave (FMCW) radar mode.

In other aspects, the radar data can include relative values for angle, velocity, and distance between the intercept aircraft 108 and the target aircraft.

The method 330 can further include one or more steps of: using the relative values for the angle, the velocity, and the distance to predict the predicted path of the target aircraft; determining the intercept point on the predicted path such that the intercept aircraft 108 is predicted to arrive at the intercept point prior to the target aircraft arriving at the intercept point; controlling the intercept aircraft 108 to hover a predefined distance range below the intercept point while waiting for the target aircraft to arrive at the intercept point; updating the predicted path and the intercept point based on additional radar data; adjusting a location of the intercept aircraft 108 in accordance with updates to the predicted path and the intercept point; and initiating the kinetic interception 134 of the target aircraft by detonating an explosive of the radar/kinetic projectile package 120 that launches projectiles in a direction to pass through the intercept point at a time when the target aircraft passes through the intercept point.

The step of initiating the kinetic interception 134 of the target aircraft further can include: detonating an explosive of the radar/kinetic projectile package 120 that is arranged to launch projectiles of the radar/kinetic projectile package 120 toward the intercept point, wherein the explosive 121 can include a mixture of liquids that are separately inert but become explosive upon being mixed. The mixture of the liquids can be enclosed in a housing that is shaped and positioned to maintain a center of gravity of the intercept aircraft 108 substantially along a vertical axis of a body of the intercept aircraft 108.

In some examples, a system can include a fuselage of an intercept aircraft 108; a radar/kinetic projectile package 120 fixed to the fuselage of the intercept aircraft 108; one or more processors like processor 404; and a memory storing instructions that, when executed by the one or more processors, configure the system to: detect a target aircraft; predict a path of the target aircraft to determine a predicted path; control the intercept aircraft 108 to fly to an intercept point along the predicted path; and initiate a kinetic interception 134 of the target aircraft that includes a self-destruction of one or more parts of the radar/kinetic projectile package 120 that performs the kinetic interception 134 of the target aircraft.

The radar/kinetic projectile package 120 can include an explosive 121 band projectiles 123 that are arranged such that detonating the explosive 121 launches the projectiles 123 along a predefined solid angle in a direction with respect to the fuselage of the intercept aircraft 108. When the instructions are executed by the one or more processors, the one or more processors are further configured to initiate a kinetic interception 134 by detonating the explosive 121 of the radar/kinetic projectile package 120.

In some aspects, the direction can be fixed with respect to the fuselage of the intercept aircraft 108. In some aspects, the direction can be upward when the intercept aircraft 108 is hovering in place. In some aspects, the direction can be substantially horizontal when the intercept aircraft 108 is traveling at near maximum velocity. In other aspects, the direction can be substantially along a direction of maximum antenna gain for a radar of the intercept aircraft 108.

In some aspects, the self-destruction of the one or more parts of the radar/kinetic projectile package 120 can include that an antenna of a radar is oriented relative to the projectiles and the explosive such that the projectiles are launched through the antenna of the radar of the intercept aircraft 108 thereby breaking the antenna of the radar into pieces that are launched in the direction.

The system can further include a radar fixed to the fuselage of the intercept aircraft 108 and configured to generate radar data by emitting electromagnetic radiation and detecting return electromagnetic radiation that is reflected from the target aircraft. In some aspects, when the instructions are executed by the one or more processors, the one or more processors are further configured to detect the target aircraft by: processing the radar data to detect the target aircraft; processing the radar data to predict the predicted path of the target aircraft and determine the intercept point on the predicted path; and In some aspects, controlling the intercept aircraft 108 to fly toward the intercept point on the predicted path.

When the instructions are executed by the one or more processors, the one or more processors are further configured to: use the radar of the intercept aircraft 108 for seeking the target aircraft; use the radar of the intercept aircraft 108 for proximity fusing the radar/kinetic projectile package; and use a same radar mode for the seeking of the target aircraft and for proximity fusing of the radar/kinetic projectile package, wherein the same radar mode that is used for seeking and for proximity fusing is a frequency modulated continuous wave (FMCW) radar mode.

In some aspects, the radar data can include relative values for angle, velocity, and distance between the intercept aircraft 108 and the target aircraft. When the instructions are executed by the one or more processors, the one or more processors can be configured to: use the relative values for the angle, the velocity, and the distance to predict the predicted path of the target aircraft; determine the intercept point on the predicted path such that the intercept aircraft 108 is predicted to arrive at the intercept point prior to the target aircraft arriving at the intercept point; control the intercept aircraft 108 to hover a predefined distance range below the intercept point while waiting for the target aircraft to arrive at the intercept point; update the predicted path and the intercept point based on additional radar data; adjust a location of the intercept aircraft 108 in accordance with updates to the predicted path and the intercept point; and initiate the kinetic interception 134 of the target aircraft by detonating an explosive of the radar/kinetic projectile package 120 that launches projectiles in the direction to pass through the intercept point at a time when the target aircraft passes through the intercept point. Any one or more of these operations can be performed by the system.

In some aspects, a radar/kinetic projectile package 120 can include an attachment member configured to attach the radar/kinetic projectile package 120 to a fuselage of intercept aircraft 108; an explosive 121; and projectiles 123 arranged next to the explosive. The projectiles 123 can be arranged such that a detonation of the explosive 121 launches the projectiles within a predefined solid angle in a direction with respect to the fuselage of the intercept aircraft 108.

In some aspects, the radar/kinetic projectile package 120 can include where a direction is fixed with respect to the fuselage of the intercept aircraft 108, the direction is upward when the intercept aircraft 108 is hovering in place; and the direction is substantially horizontal when the intercept aircraft 108 is traveling at near maximum velocity.

In some aspects, the radar/kinetic projectile package 120 can include a radar antenna. The projectiles 123 can be arranged such that the detonation of the explosive destroys the radar antenna by launching one or more of the projectiles through the radar antenna.

The direction of the detonation of the radar/kinetic projectile package 120 can vary. The direction can be one or more of: fixed with respect to the body of the intercept aircraft 108; upward when the intercept aircraft 108 is hovering in place; substantially horizontal when the intercept aircraft 107 is traveling at near maximum velocity; and/or substantially along a direction of maximum antenna gain for a radar of the intercept aircraft 108. In some cases, the radar/kinetic projectile package 120 can be configured below the intercept aircraft 108. In this case, the direction of the detonation can be substantially downward and the intercept aircraft 108 can be positioned above the target aircraft. In another case, the detonation direction can be substantially upward when the radar/kinetic projectile package is configured on a top surface of the intercept aircraft 108 and the intercept aircraft is stationary or in some cases it may be moving.

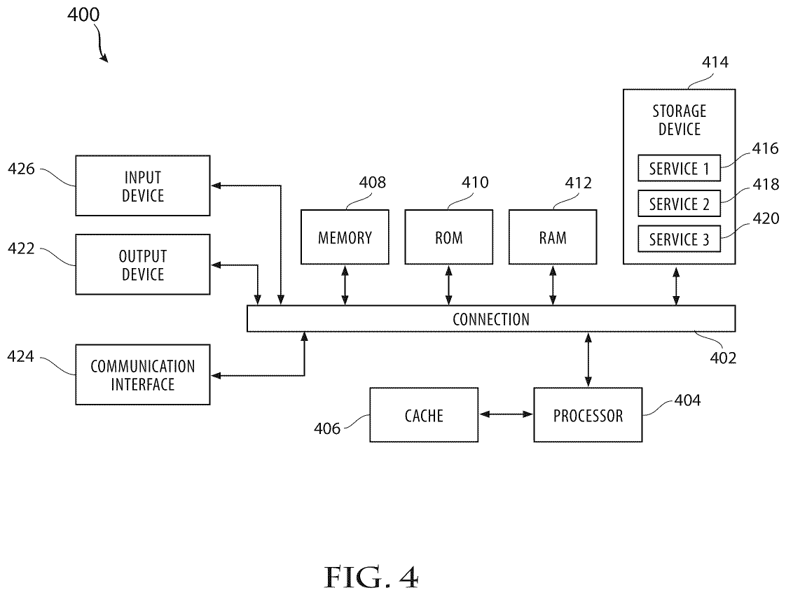

FIG. 4 shows an example of computing system 400. The computing system 400 can be a controller or one of the one or more processors 214. The computing system 400 can perform the functions of components of aircraft environment 100 or of the intercept aircraft 108. The computing system 400 can be part of a distributed computing network in which several computers perform respective steps in method 300. The computing system 400 can be connected to the other parts of the distributed computing network via connection 402 or communication interface 424. Connection 402 can be a physical connection via a bus, or a direct connection into processor 404, such as in a chipset architecture. Connection 402 can also be a virtual connection, networked connection, or logical connection.

In some example implementations, computing system 400 is a distributed system in which the functions described in this disclosure can be distributed within a datacenter, multiple data centers, a peer network, etc. In some example implementations, one or more of the described system components represents many such components each performing some or all of the function for which the component is described. In some example implementations, the components can be physical or virtual devices.

Example computing system 400 includes at least one processing unit (CPU or processor) 404 and connection 402 that couples various system components including system memory 408, such as read-only memory (ROM) 410 and random access memory (RAM) 412 to processor 404. Computing system 400 can include a cache of high-speed memory 406 connected directly with, in close proximity to, or integrated as part of processor 404. Processor 404 may essentially be a completely self-contained computing system, containing multiple cores or processors, a bus, memory controller, cache, etc. A multi-core processor may be symmetric or asymmetric.

Processor 404 can include any general-purpose processor and a hardware service or software service, such as services 416, 418, and 420 stored in storage device 414, configured to control processor 404 as well as a special-purpose processor where software instructions are incorporated into the actual processor design.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include a communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some example implementations, a hardware service that performs a particular function can include the software component stored in a computer-readable medium in connection with the necessary hardware components, such processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some example implementations, a service can be software that resides in memory of the intercept aircraft 108 or of the one or more processors 214 and performs one or more functions of method 300 when a processor executes the software associated with the service. In some example implementations, a service is a program or a collection of programs that carry out a specific function. In some example implementations, a service can be considered a server. The memory can be a non-transitory computer-readable medium.

In some example implementations, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

It is noted that in one aspect, a computer or computers can be deployed upon a flying machine, such as a drone, or as part of a projectile module that is removably attached to a drone in which interfaces with the control system of the drone. The computer or computer devices may also be deployed as a separate control system which can communicate with a drone and/or a projectile module and/or projectile itself. Any wireless protocol is contemplated as being utilized for such communication.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some example implementations, a service can be software that resides in memory of a client device and/or one or more servers of a content management system and perform one or more functions when a processor executes the software associated with the service. In some example implementations, a service is a program, or a collection of programs that carry out a specific function. In some example implementations, a service can be considered a server. The memory can be a non-transitory computer-readable medium.

In some example implementations the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Clause 1. A system comprising: a fuselage of an intercept aircraft; a radar/kinetic projectile package fixed to the fuselage of the intercept aircraft; one or more processors; and a memory storing instructions that, when executed by the one or more processors, configure the system to: detect a target aircraft; predict a path of the target aircraft to determine a predicted path; control the intercept aircraft to fly to an intercept point along the predicted path; and initiate a kinetic interception of the target aircraft that includes a self-destruction of one or more parts of the radar/kinetic projectile package 120 that performs the kinetic interception of the target aircraft.

Clause 2. The system of clause 1, wherein: the radar/kinetic projectile package comprises an explosive and projectiles that are arranged such that detonating the explosive launches the projectiles along a predefined solid angle in a direction with respect to the fuselage of the intercept aircraft, and when the stored instructions are executed by the one or more processors, the one or more processors are further configured to initiate a kinetic interception by detonating the explosive of the radar/kinetic projectile package.

Clause 3. The system of clause 1 or clause 2, wherein the direction is one or more of: fixed with respect to the body of the intercept aircraft; upward when the intercept aircraft is hovering in place; substantially horizontal when the intercept aircraft is traveling at near maximum velocity; substantially along a direction of maximum antenna gain for a radar of the intercept aircraft; substantially downward when the radar/kinetic projectile package is configured below the intercept aircraft; and substantially upward when the radar/kinetic projectile package is configured on a top surface of the intercept aircraft and the intercept aircraft is stationary.

Clause 4. The system of clause 2 or any of the preceding clauses, wherein the self-destruction of the one or more parts of the radar/kinetic projectile package includes that an antenna of a radar is arranged with respect to the projectiles and the explosive such that the projectiles are launched through an antenna of a radar of the intercept aircraft thereby breaking the antenna of the radar into pieces that are launched in the direction.

Clause 5. The system of clause 2 or any of the preceding clauses, wherein the projectiles comprise more than one hundred projectiles and wherein the more than one hundred projectiles comprise ball bearings, metal pellets, or fragments which can be metal or ceramic.

Clause 6. The system of clause 2 or any of the preceding clauses, further comprises: a radar fixed to the fuselage of the intercept aircraft and configured to generate radar data by emitting electromagnetic radiation and detecting return electromagnetic radiation that is reflected from a target aircraft, wherein, when the stored instructions are executed by the one or more processors, the one or more processors are further configured to detect the target aircraft by: processing the radar data to detect the target aircraft; processing the radar data to predict the predicted path of the target aircraft and determine an intercept point on the predicted path; and controlling the intercept aircraft to fly toward the intercept point on the predicted path.

Clause 7. The system of clause 6 or any of the preceding clauses, wherein, when the stored instructions are executed by the one or more processors, the one or more processors are further configured to: use the radar of the intercept aircraft to seek for the target aircraft; use the radar of the intercept aircraft as a proximity fuse for the projectile device; and use a same radar mode to seek for the target aircraft and for the proximity fuse of the projectile device.

Clause 8. The system of clause 7 or any of the preceding clauses, wherein the same radar mode that is used to seek and for the proximity fuse is a frequency-modulated continuous wave (FMCW) radar mode.

Clause 9. The system of clause 6 or any of the preceding clauses, wherein the radar data comprises relative values for angle, velocity, and distance between the intercept aircraft and the target aircraft, and, when the stored instructions are executed by the one or more processors, the one or more processors are further configured to: use the relative values for the angle, the velocity, and the distance to predict the predicted path of the target aircraft; determine the intercept point on the predicted path such that the intercept aircraft is predicted to arrive at the point prior to the target aircraft arriving at the intercept point; control the intercept aircraft to hover a predefined distance range below the intercept point while waiting for the target aircraft to arrive at the intercept point; update the predicted path and the intercept point based on additional radar data; adjust a location of the intercept aircraft in accordance with updates to the predicted path and the intercept point; and initiate the kinetic interception of the target aircraft by detonating an explosive of the projectile device that launches projectiles in the direction to pass through the intercept point at a time when the target aircraft passes through the intercept point.

Clause 10. The system of clause 1 or any of the preceding clauses, wherein initiating the kinetic interception of the target aircraft further includes: detonating an explosive of the radar/kinetic projectile package that is arranged to launch projectiles of the radar/kinetic projectile package toward the intercept point, wherein the explosive comprises a mixture of liquids that are separately inert but become explosive upon being mixed, and the mixture of liquids is enclosed in a housing that is shaped and positioned to maintain a center of gravity of the intercept aircraft substantially along a vertical axis of a body of the intercept aircraft.

Clause 11. A system comprising: a first flying machine; a projectile device fixed to the first flying machine and configured to launch one or more projectiles in a direction with respect to the first flying machine; a radar fixed to the first flying machine and configured to emit electromagnetic radiation, detect return electromagnetic radiation that is reflected from a second flying machine, and generate radar data based on the detected return electromagnetic radiation; one or more processors; and a memory storing instructions that, when executed by the one or more processors, configure the system to: detect, based on the radar data, the second flying machine, predict, based on the radar data, a prospective path of the second flying machine, control the first flying machine to fly toward an intercept point on the prospective path, and initiate, using the projectile device, a kinetic interception of the second flying machine at the intercept point.

Clause 12. The system of clause 11 or any of the preceding clauses, further comprising: a ground radar configured to communicate with the first flying machine and configured to generate other radar data that together with the radar data is used by the one or more processors to predict the prospective path of the second flying machine.

Clause 13. The system of clause 11 or any of the preceding clauses, wherein the system: is configured to perform a function of seeking the second flying machine and being a proximity fuse for the projectile device; and the radar is configured to use a same radar mode to seek for the second flying machine and as the proximity fuse of the projectile device.

Clause 14. The system of clause 11 or any of the preceding clauses, wherein the same radar mode that is used to seek and for the proximity fuse is a frequency modulated continuous wave (FMCW) radar mode.

Clause 15. The system of clause 11 or any of the preceding clauses, wherein the one or more processors use the radar data for the proximity fuse by determining a distance between the first flying machine and the second flying machine, and, when the distance is within a predefined range of distances, detonating an explosive of the projectile device to launch the one or more projectiles in the direction.

Clause 16. The system of clause 11 or any of the preceding clauses, wherein: the radar data includes values for an angle, a velocity, and a distance relative to the first flying machine and the second flying machine; and when the stored instructions are executed by the one or more processors, the one or more processor is further configured to: use the relative values for the angle, the velocity, and the distance to predict the prospective path of the second flying machine; determine the intercept point on the prospective path such that the first flying machine is predicted to arrive at the point prior to the second flying machine arriving at the intercept point; control the first flying machine to hover a predefined distance range below the intercept point while waiting for second flying machine to arrive at the intercept point; update the prospective path and the intercept point based on additional radar data, and adjust a position of the first flying machine in accordance with the updated prospective path and the updated intercept point; and initiate the kinetic interception of the second flying machine by detonating an explosive of the projectile device that launches the one or more projectiles in the direction to pass through the intercept point at a predicted time of the second flying machine to pass through the intercept point.

Clause 17. The system of clause 16 or any of the preceding clauses, wherein, when the stored instructions are executed by the one or more processors, the one or more processors is further configured to: self-destruct one or more parts of the radar upon the detonation of the explosive of the projectile device.

Clause 18. The system of clause 11 or any of the preceding clauses, wherein the one or more projectiles comprises more than one hundred projectiles wherein the more than one hundred projectiles comprise ball bearings, metal pellets, or fragments that can be metal or ceramic.

Clause 19. The system of clause 11 or any of the preceding clauses, wherein the projectile device comprises an explosive on a first side of the one or more projectiles, and an antenna of the radar is arranged on a second side of the one or more projectiles that is opposite side to the first side of the one or more projectiles, wherein detonating the explosive launches the one or more projectiles through the antenna thereby shredding the antenna producing antenna pieces as additional projectiles that are launched in the direction with respect to the first flying machine.

Clause 20. The system of clause 11 or any of the preceding clauses, wherein the projectile device comprises an explosive on a first side of the one or more projectiles, the explosive being configured to launch the one or more projectiles in the direction when the explosive is denoted, and the explosive being a mixture of liquid binaries that are separately inert.

Clause 21. The system of clause 20 or any of the preceding clauses, wherein: the explosive is housed in a container with an inner volume that is shaped to direct an explosion of the explosive according to a predefined shape; and the one or more projectiles is arranged with respect to the shaped explosive such that the explosion of the explosive launches the one or more projectiles within a predefined solid angle and predefined dispersal pattern.

Clause 22. The system of clause 21 or any of the preceding clauses, wherein the container is three-dimensional (3D) printed with the inner volume that is shaped to direct the explosion according to the predefined shape.

Clause 23. The system of clause 11 or any of the preceding clauses wherein, when the stored instructions are executed by the one or more processors, the one or more processors is further configured to: limit an acceleration of the first flying machine below a predefined threshold at which compression and shockwaves in the explosive result in a likelihood of detonation.

Clause 24. The system of clause 11 or any of the preceding clauses, wherein the first flying machine is configured for vertical take-off and landing.

Clause 25. The system of clause 21 or any of the preceding clauses, wherein the predefined dispersal pattern is substantially uniform over the predefined solid angle.

Clause 26. The system of clause 11 or any of the preceding clauses, wherein: an antenna of the radar and the projectile device both have a fixed orientation with respect to a body of the first flying machine such that toward the direction such that the projectile device is orientated to launch the one or more projectiles in the direction and the antenna of the radar is orientated to have an antenna gain that is substantially maximum in the direction; and the direction is substantially along a travel direction of the first flying machine when the first flying machine is traveling at a maximum speed.

Clause 27. The system of clause 26 or any of the preceding clauses, wherein the direction points upward when the first flying machine is hovering in place.

Clause 28. The system of clause 27 or any of the preceding clauses, where in the direction is an angle of less than 45° from normal with respect to a top of the body of the first flying machine.

Clause 29. The system of clause 21 or any of the preceding clauses, wherein the inner volume of the container is shaped to maintain a center of gravity for a combination of the first flying machine, the prospective path, and the radar that is substantially along a vertical axis of the first flying machine.

Clause 30. The system of clause 11 or any of the preceding clauses, wherein the radar and the projectile device are rigidly fixed to the first flying machine.

Clause 31. The system of clause 30 or any of the preceding clauses, wherein the radar comprises a phased array the is configured to perform beam steering.

Clause 32. The system of clause 11 or any of the preceding clauses, further comprising: a first wireless communication transceiver fixed to the first flying machine; a second wireless communication transceiver on a ground station and configured to communicate with the first wireless communication transceiver; and a ground radar configured to transmit radio waves and detect scattered radio waves from the second flying machine to generate other radar data, wherein the one or more processors use the radar data and the other radar data to predict the prospective path of the second flying machine.

Clause 33. The system of clause 32 or any of the preceding clauses, further comprising: a third flying machine configured with another projectile device to perform another kinetic interception when the kinetic interception by the first flying machine fails to disable the second flying machine.

Clause 34. The system of clause 11 or any of the preceding clauses, wherein the projectile device is detachable from the first flying machine and the projectile device includes a communication port for communicating between the projectile device and at least one processor of the one or more processors.

Clause 35. The system of clause 34 or any of the preceding clauses, wherein the projectile device snaps onto the first flying machine, and, after snapping onto the first flying machine, the projectile device is secured at two or more points via fasteners extending through the projectile device into a fuselage/body of the first flying machine.

Clause 36. The system of clause 34 or any of the preceding clauses, wherein the communication port is a wired port that electrically connects the projectile device to the first flying machine when the projectile device is fixed to the first flying machine.

Clause 37. The system of clause 36 or any of the preceding clauses, wherein the communication port is a parallel port, a serial port, a DIN port, an RS-232C port, an RS-422A port, an RS-485 port, DE-9 port, a DB-25 port, a USB port, an ethernet port, a ruggedized port, or a firewire port.

Clause 28. The system of clause 26 or any of the preceding clauses, wherein the communication port provides electrical power from the first flying machine to the projectile device.

Clause 39. The system of clause 34 or any of the preceding clauses, wherein the first flying machine has an electrical power supply, and the projectile device snaps has another electrical power supply that is separate from the electrical power supply of the first flying machine.

Clause 40. The system of clause 34 or any of the preceding clauses, wherein the communication port is a wireless port.

Clause 41. The system of clause 40 or any of the preceding clauses, wherein the communication port is a BLUETOOTH communication port, a BLUETOOTH LE communication port, a NEAR FIELD communication port, a ZIGBEE communication port, a Z-WAVE communication port, a 6LoWPAN communication port, a WIFI communication port, a 3G communication port, a 4G communication port, communication port, a 5G communication port, an LTE communication port, a secure communication port, or an encrypted communication port.

Clause 42. A method of kinetic interception of a target aircraft, the method comprising: detecting, by an intercept aircraft, a target aircraft; predicting a path of the target aircraft to determine a predicted path; controlling the intercept aircraft to fly to an intercept point along the predicted path; and initiating a kinetic interception of the target aircraft that includes a self-destruction of one or more parts of a radar/kinetic projectile package that performs the kinetic interception of the target aircraft.

Clause 43. The method of clause 42 or any of the proceeding method clauses, wherein initiating the kinetic interception of the target aircraft further includes: detonating an explosive of the radar/kinetic projectile package that is arranged to launch projectiles of the radar/kinetic projectile package along a predefined solid angle in a direction with respect to a body of the intercept aircraft.

Clause 44. The method of clause 43 or any of the proceeding method clauses, wherein the direction is fixed with respect to the body of the intercept aircraft; the direction is upward when the intercept aircraft is hovering in place; the direction is substantially horizontal when the aircraft is traveling at near maximum velocity; and the direction is substantially along a direction of maximum antenna gain for a radar of the intercept aircraft.

Clause 45. The method of clause 43 or any of the proceeding method clauses, wherein the self-destruction of the one or more parts of the radar/kinetic projectile package includes that an antenna of a radar is arranged with respect to the projectiles and the explosive such that the projectiles are launched through an antenna of a radar of the intercept aircraft thereby breaking the antenna of the radar into pieces that are launched in the direction.

Clause 46. The method of clause 43 or any of the proceeding method clauses, wherein the projectiles comprise more than one hundred projectiles and wherein the more than one hundred projectiles comprise ball bearings, metal pellets or fragments that can be metal or ceramic.

Clause 47. The method of clause 42 or any of the proceeding method clauses, wherein detecting the target aircraft further comprises: generating, by a radar of the intercept aircraft, radar data by emitting electromagnetic radiation and detecting return electromagnetic radiation that is reflected from a target aircraft; processing the radar data using one or more processors to detect the target aircraft; processing the radar data using the one or more processors to predict the predicted path of the target aircraft and determine the target intercept point on the predicted path; and flying the intercept aircraft toward the intercept point on the predicted path.

Clause 48. The method of clause 47, further comprising: using the radar of the intercept aircraft to seek for the target aircraft; using the radar of the intercept aircraft to be a proximity fuse of the projectile device; and using a same radar mode to seek for the target aircraft and for the proximity fuse of the projectile device.

Clause 49. The method of clause 48, wherein the same radar mode that is used to seek and for the proximity fuse is a frequency modulated continuous wave (FMCW) radar mode.

Clause 50. The method of clause 47, wherein: the radar data comprises relative values for angle, velocity, and distance between the intercept aircraft and the target aircraft; and the method further comprises: using the relative values for the angle, the velocity, and the distance to predict the predicted path of the target aircraft; determining the intercept point on the predicted path such that the intercept aircraft is predicted to arrive at the point prior to the target aircraft arriving at the intercept point; controlling the intercept aircraft to hover a predefined distance range below the intercept point while waiting for the target aircraft to arrive at the intercept point; updating the predicted path and the intercept point based on additional radar data; adjusting a location of the intercept aircraft in accordance with updates to the predicted path and the intercept point; and initiating the kinetic interception of the target aircraft by detonating an explosive of the projectile device that launches projectiles in the direction to pass through the intercept point at a time when the target aircraft passes through the intercept point.

Clause 51. The method of clause 42, wherein initiating the kinetic interception of the target aircraft further includes: detonating an explosive of the radar/kinetic projectile package that is arranged to launch projectiles of the radar/kinetic projectile package toward the intercept point, wherein the explosive comprises a mixture of liquids that are separately inert but become explosive upon being mixed, and the mixture of liquids is enclosed in a housing that is shaped and positioned to maintain a center of gravity of the intercept aircraft substantially along a vertical axis of a body of the intercept aircraft.

Clause 52. A method using a first flying machine to perform a kinetic interception of a second flying machine, the method comprising: generating radar data at a radar fixed to a first flying machine, the radar data being generated by emitting electromagnetic radiation and detecting return electromagnetic radiation that is reflected from a second flying machine and generating the radar data based on the detected return electromagnetic radiation; processing the radar data using one or more processors to detect the second flying machine; processing the radar data using the one or more processors to predict a prospective path of the second flying machine and determine an intercept point on the prospective path; flying the first flying machine toward the intercept point on the prospective path; and initiating a kinetic interception of the second flying machine at the intercept point using a projectile device fixed to the first flying machine, wherein the projectile device launches one or more projectiles to intercept the second flying machine as the second flying machine flies through the intercept point.

Clause 53. The method of clause 52 or any of the proceeding method clause, further comprising: acquiring other radar data from another radar that is a ground radar, a satellite-based radar or another airborne radar; and predicting the prospective path by the one or more processors processing the radar data to determine the prospective path of the second flying machine.

Clause 54. The method of clause 52 or any of the proceeding method clause or clause 33, further comprising: using the radar of the first flying machine to seek for the second flying machine; using the radar of the first flying machine to be a proximity fuse for the projectile device; and using a same radar mode to seek for the second flying machine and for the proximity fuse of the projectile device.

Clause 55. The method of clause 54 or any of the proceeding method clauses, wherein the same radar mode that is used to seek and for the proximity fuse is a frequency modulated continuous wave (FMCW) radar mode.

Clause 56. The method of clause 52 or any of the proceeding method clause or any of the proceeding method clauses, further comprising: processing, at the one or more processors, the radar data for the proximity fuse by determining a distance between the first flying machine and the second flying machine, and, when the distance is within a predefined range of distances, detonating an explosive of the projectile device to launch the one or more projectiles in the direction.

Clause 57. The method of clause 52 or any of the proceeding method clause or any of the proceeding method clauses, wherein: the radar data comprises relative values for angle, velocity, and distance between the first flying machine and the second flying machine; and the method further comprises: using the relative values for the angle, the velocity, and the distance to predict the prospective path of the second flying machine; determining the intercept point on the prospective path such that the first flying machine is predicted to arrive at the point prior to the second flying machine arriving at the intercept point; controlling the first flying machine to hover a predefined distance range below the intercept point while waiting for second flying machine to arrive at the intercept point; updating the prospective path and the intercept point based on additional radar data, and adjusting a position of the first flying machine in accordance with the updated prospective path and the updated intercept point; and initiating the kinetic interception of the second flying machine by detonating an explosive of the projectile device that launches the one or more projectiles in the direction to pass through the intercept point at a predicted time of the second flying machine to pass through the intercept point.

Clause 58. The method of clause 57 or any of the proceeding method clauses, further comprising: self-destructing one or more parts of the radar upon the detonation of the explosive of the projectile device.

Clause 59. The method of clause 52 or any of the proceeding method clause or any of the proceeding method clauses, wherein the one or more projectiles comprises more than one hundred projectiles and wherein the more than one hundred projectiles comprise ball bearings, metal pellets or fragments that can be metal or ceramic.

Clause 60. The method of clause 52 or any of the proceeding method clause or any of the proceeding method clauses, wherein the projectile device comprises an explosive on a first side of the one or more projectiles, and an antenna of the radar is arranged on a second side of the one or more projectiles that is opposite side to the first side of the one or more projectiles, wherein detonating the explosive launches the one or more projectiles through the antenna thereby shredding the antenna producing antenna pieces as additional projectiles that are launched in the direction with respect to the first flying machine.

Clause 61. The method of clause 52 or any of the proceeding method clause or any of the proceeding method clauses, wherein the projectile device comprises an explosive on a first side of the one or more projectiles, the explosive being configured to launch the one or more projectiles in the direction when the explosive is denoted, and the explosive being a mixture of liquid binaries that are separately inert.

Clause 62. The method of clause 61 or any of the proceeding method clauses, wherein: housing the explosive in a container with an inner volume that is shaped to direct an explosion of the explosive according to a predefined shape; and the one or more projectiles are arranged with respect to the explosive such that the explosion of the explosive launches the one or more projectiles within a predefined solid angle and predefined dispersal pattern.

Clause 63. The method of clause 62 or any of the proceeding method clauses, wherein the predefined dispersal pattern is substantially uniform over the predefined solid angle.

Clause 64. The method of clause 62, wherein the container is three-dimensional (3D) printed with the inner volume that is shaped to direct the explosion according to the predefined shape.

Clause 65. The method of clause 62 or any of the proceeding method clauses, further comprising: limiting an acceleration of the first flying machine below a predefined threshold at which compression and shockwaves in the explosive result in a likelihood of detonation.

Clause 66. The method of clause 52 or any of the proceeding method clause or any of the proceeding method clauses, wherein the first flying machine is configured for vertical take-off and landing.

Clause 67. A radar/kinetic projectile package, comprising: an attachment member configured to attach the radar/kinetic projectile package to a fuselage of intercept aircraft; an explosive; and projectiles arranged next to the explosive, wherein the projectiles are arranged such that a detonation of the explosive launches the projectiles within a predefined solid angle in a direction with respect to the fuselage of the intercept aircraft.

Clause 68. The radar/kinetic projectile package of clause 67, wherein the direction is fixed with respect to the body of the intercept aircraft; the direction is upward when the intercept aircraft is hovering in place; and the direction is substantially horizontal when the aircraft is traveling at near maximum velocity.

Clause 69. The radar/kinetic projectile package of clause 68 or any of the preceding radar/kinetic projectile package clauses, further comprising: a radar antenna, wherein the projectiles are arranged such that the detonation of the explosive destroys the radar antenna by launching one or more of the projectiles through the radar antenna.

Clause 70. The radar/kinetic projectile package of clause 69 or any of the preceding radar/kinetic projectile package clauses, wherein the direction is substantially along a direction of maximum antenna gain for a radar of the intercept aircraft.

What is claimed is:

1. A method of kinetically intercepting of an aircraft, the method comprising:
detecting, by an intercept aircraft, a target aircraft;
predicting a path of the target aircraft to determine a predicted path;
controlling the intercept aircraft to fly to an intercept point along the predicted path; and
initiating a kinetic interception of the target aircraft that includes a self-destruction of one or more parts of a radar/kinetic projectile package that performs the kinetic interception of the target aircraft.

2. The method of claim 1, wherein initiating the kinetic interception of the target aircraft further includes:
detonating an explosive of the radar/kinetic projectile package that is arranged to launch projectiles of the radar/kinetic projectile package along a predefined solid angle in a direction with respect to a body of the intercept aircraft.

3. The method of claim 2, wherein the direction is one or more of:
fixed with respect to the body of the intercept aircraft;
upward when the intercept aircraft is hovering in place;
substantially horizontal when the intercept aircraft is traveling at near maximum velocity;
substantially along a direction of maximum antenna gain for a radar of the intercept aircraft;
substantially downward when the radar/kinetic projectile package is configured below the intercept aircraft; and
substantially upward when the radar/kinetic projectile package is configured on a top surface of the intercept aircraft and the intercept aircraft is stationary.

4. The method of claim 2, wherein the self-destruction of the one or more parts of the radar/kinetic projectile package includes that an antenna of a radar is oriented relative to the projectiles and the explosive such that the projectiles are launched through the antenna of the radar of the intercept aircraft thereby breaking the antenna of the radar into pieces that are launched in the direction.

5. The method of claim 2, wherein the projectiles comprise more than one hundred projectiles and wherein the more than one hundred projectiles comprise ball bearings, metal pellets, or fragments.

6. The method of claim 1, wherein detecting the target aircraft further comprises:
generating, by a radar of the intercept aircraft, radar data by emitting electromagnetic radiation and detecting return electromagnetic radiation that is reflected from the target aircraft;
processing the radar data using one or more processors to detect the target aircraft;
processing the radar data using the one or more processors to predict the predicted path of the target aircraft and determine the intercept point on the predicted path; and
flying the intercept aircraft toward the intercept point on the predicted path.

7. The method of claim 6, further comprising:
using the radar of the intercept aircraft to seek for the target aircraft;
using the radar of the intercept aircraft as a proximity fuse of the radar/kinetic projectile package; and
using a same radar mode to seek for the target aircraft and for the proximity fuse of the radar/kinetic projectile package.

8. The method of claim 7, wherein the same radar mode that is used to seek and for the proximity fuse is a frequency-modulated continuous wave (FMCW) radar mode.

9. The method of claim 6, wherein:
the radar data comprises relative values for angle, velocity, and distance between the intercept aircraft and the target aircraft; and
the method further comprises:
using the relative values for the angle, the velocity, and the distance to predict the predicted path of the target aircraft;
determining the intercept point on the predicted path such that the intercept aircraft is predicted to arrive at the intercept point prior to the target aircraft arriving at the intercept point;
controlling the intercept aircraft to hover a predefined distance range below the intercept point while waiting for the target aircraft to arrive at the intercept point;
updating the predicted path and the intercept point based on additional radar data;
adjusting a location of the intercept aircraft in accordance with updates to the predicted path and the intercept point; and
initiating the kinetic interception of the target aircraft by detonating an explosive of the radar/kinetic projectile package that launches projectiles in a direction to pass through the intercept point at a time when the target aircraft passes through the intercept point.

10. The method of claim 1, wherein initiating the kinetic interception of the target aircraft further includes:
detonating an explosive of the radar/kinetic projectile package that is arranged to launch projectiles of the radar/kinetic projectile package toward the intercept point, wherein the explosive comprises a mixture of liquids that are separately inert but become explosive upon being mixed, and
the mixture of the liquids is enclosed in a housing that is shaped and positioned to maintain a center of gravity of the intercept aircraft substantially along a vertical axis of a body of the intercept aircraft.

11. A system comprising:
a fuselage of an intercept aircraft;
a radar/kinetic projectile package fixed to the fuselage of the intercept aircraft;
one or more processors; and
a memory storing instructions that, when executed by the one or more processors, configure the system to:
detect a target aircraft;
predict a path of the target aircraft to determine a predicted path;
control the intercept aircraft to fly to an intercept point along the predicted path; and
initiate a kinetic interception of the target aircraft that includes a self-destruction of one or more parts of the radar/kinetic projectile package that performs the kinetic interception of the target aircraft.

12. The system of claim 11, wherein:
the radar/kinetic projectile package comprises an explosive and projectiles that are arranged such that detonating the explosive launches the projectiles along a predefined solid angle in a direction with respect to the fuselage of the intercept aircraft, and
when the instructions are executed by the one or more processors, the one or more processors are further configured to initiate a kinetic interception by detonating the explosive of the radar/kinetic projectile package.

13. The system of claim 12, wherein
the direction is fixed with respect to the fuselage of the intercept aircraft;
the direction is upward when the intercept aircraft is hovering in place;
the direction is substantially horizontal when the intercept aircraft is traveling at near maximum velocity; and
the direction is substantially along a direction of maximum antenna gain for a radar of the intercept aircraft.

14. The system of claim 12, wherein the self-destruction of the one or more parts of the radar/kinetic projectile package includes that an antenna of a radar is oriented relative to the projectiles and the explosive such that the projectiles are launched through the antenna of the radar of the intercept aircraft thereby breaking the antenna of the radar into pieces that are launched in the direction.

15. The system of claim 12, further comprises:
a radar fixed to the fuselage of the intercept aircraft and configured to generate radar data by emitting electromagnetic radiation and detecting return electromagnetic radiation that is reflected from the target aircraft, wherein,
when the instructions are executed by the one or more processors, the one or more processors are further configured to detect the target aircraft by:
processing the radar data to detect the target aircraft;
processing the radar data to predict the predicted path of the target aircraft and determine the intercept point on the predicted path; and
controlling the intercept aircraft to fly toward the intercept point on the predicted path.

16. The system of claim 15, wherein, when the instructions are executed by the one or more processors, the one or more processors are further configured to:
use the radar of the intercept aircraft to seek for the target aircraft;
use the radar of the intercept aircraft as a proximity fuse the radar/kinetic projectile package; and
use a same radar mode to seek for the target aircraft and as the proximity fuse of the radar/kinetic projectile package, wherein the same radar mode that is used to seek and for the proximity fuse is a frequency modulated continuous wave (FMCW) radar mode.

17. The system of claim 15, wherein
the radar data comprises relative values for angle, velocity, and distance between the intercept aircraft and the target aircraft, and,
when the instructions are executed by the one or more processors, the one or more processors are further configured to:
use the relative values for the angle, the velocity, and the distance to predict the predicted path of the target aircraft;
determine the intercept point on the predicted path such that the intercept aircraft is predicted to arrive at the intercept point prior to the target aircraft arriving at the intercept point;
control the intercept aircraft to hover a predefined distance range below the intercept point while waiting for the target aircraft to arrive at the intercept point;
update the predicted path and the intercept point based on additional radar data;
adjust a location of the intercept aircraft in accordance with updates to the predicted path and the intercept point; and
initiate the kinetic interception of the target aircraft by detonating an explosive of the radar/kinetic projectile package that launches projectiles in the direction to pass through the intercept point at a time when the target aircraft passes through the intercept point.

18. A radar/kinetic projectile package, comprising:
an attachment member configured to attach the radar/kinetic projectile package to a fuselage of intercept aircraft;
an explosive; and
projectiles arranged next to the explosive, wherein
the projectiles are arranged such that a detonation of the explosive launches the projectiles within a predefined solid angle in a direction with respect to the fuselage of the intercept aircraft.

19. The radar/kinetic projectile package of claim 18, wherein
the direction is fixed with respect to the fuselage of the intercept aircraft;
the direction is upward when the intercept aircraft is hovering in place; and
the direction is substantially horizontal when the intercept aircraft is traveling at near maximum velocity.

20. The radar/kinetic projectile package of claim 19, further comprising:
a radar antenna, wherein
the projectiles are arranged such that the detonation of the explosive destroys the radar antenna by launching one or more of the projectiles through the radar antenna.
